(19) United States
(12) Patent Application Publication
(10) Pub. No.: US 2024/0005024 A1
(43) Pub. Date: Jan. 4, 2024

(54) ORDER PRESERVING DATASET OBFUSCATION

(71) Applicant: ServiceNow, Inc., Santa Clara, CA (US)

(72) Inventors: Adrian Spalka, San Francisco, CA (US); Pierre Francois Rohel, San Francisco, CA (US)

(21) Appl. No.: 17/959,121

(22) Filed: Oct. 3, 2022

Related U.S. Application Data
(60) Provisional application No. 63/356,778, filed on Jun. 29, 2022.

(51) Int. Cl. G06F 21/62; G06F 16/22; G06F 21/60

(52) U.S. Cl. CPC G06F 21/6227; G06F 21/6245; G06F 16/221; G06F 21/602

(57) ABSTRACT

A determination is made to obfuscate a protected dataset including data elements that are to remain comparable with one another after the obfuscation. An obfuscation function for the protected dataset is selected wherein the obfuscation function is a monotonic one-way function. One or more parameters for the obfuscation function are automatically determined based at least in part on a secret value. Using one or more processors, the protected dataset is automatically obfuscated to generate an obfuscated version using the obfuscation function with the determined one or more parameters. Computer access to the obfuscated version of the protected dataset is provided as a comparable alternative for the protected dataset.

### CROSS REFERENCE TO OTHER APPLICATIONS

This application claims priority to U.S. Provisional Patent Application No. 63/356,778 entitled OBFUSCATION OF A DATASET WHILE MAINTAINING COMPARABILITY filed Jun. 29, 2022, which is incorporated herein by reference for all purposes.

### BACKGROUND OF THE INVENTION

Cloud services offer application functionality that is often applied to client data. Instead of hosting the data locally, the client data can be hosted remotely by the cloud service, minimizing the administrative costs to clients for managing their own data. By utilizing a cloud application service, a client can retrieve and analyze client data while relying on the computing performance, reliability, and administrative support, among other benefits, of the application service. For example, a cloud service can be used to submit, store, retrieve, and query employee documents and information related to human resources. As another example, a cloud service can be used to manage customer sales and contact information. Often the client data is highly sensitive and can contain information such as personal employee information, transaction amounts, and other confidential or sensitive information.

### BRIEF DESCRIPTION OF THE DRAWINGS

Various embodiments of the invention are disclosed in the following detailed description and the accompanying drawings.

FIG. 1 is a block diagram illustrating an embodiment of an obfuscation system that preserves comparability.

FIG. 2 is a flow chart illustrating an embodiment of a process for obfuscating a dataset while preserving comparability.

FIG. 3 is a flow chart illustrating an embodiment of a process for determining an obfuscation function that preserves comparability.

FIG. 4 is a flow chart illustrating an embodiment of a process for protecting a dataset using an obfuscation function.

FIG. 5 is a flow chart illustrating an embodiment of a process for performing a comparison query on an obfuscated dataset.

FIG. 6 is a functional diagram illustrating a programmed computer system for obfuscating a dataset while preserving comparability in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Data element obfuscation while maintaining comparability is disclosed. Using the disclosed techniques, a dataset can be obfuscated while preserving the ordered nature of the data elements in the obfuscated data. In various embodiments, when confidential data must not be disclosed, the disclosed techniques utilize a one-way function to obfuscate the data elements while preserving the ability to compare the data elements in their obfuscated form. For example, a table in a database stores prices as amounts in U.S. dollars. The amounts are confidential and access to their plain text values is limited. Using the disclosed techniques and embodiments, an obfuscation service can determine whether a first price is smaller than a second price without knowing their actual amounts. When provided with a secret key, the obfuscation service can compare the first and second price without knowing the actual values of the first or second price, for example, by comparing the obfuscated versions of the first and second prices. In various embodiments, the disclosed techniques utilize a one-way function that maps a confidential domain value x to a non-confidential range value ƒ(x) while preserving linear order. For example, the disclosed techniques can utilize a monotonic one-way polynomial obfuscation function with coefficients generated for each protected dataset from a secret key.

In some embodiments, a determination is made to obfuscate a protected dataset including data elements that are to remain comparable with one another after the obfuscation. For example, a confidential data set requires protection, and access to the plain text versions of the data elements is strictly limited. For improved security, the data elements are to be stored in an obfuscated form but a form that preserves the ability to compare them to one another. In some embodiments, an obfuscation function for the protected dataset is selected wherein the obfuscation function is a monotonic one-way function. For example, for each dataset that requires obfuscation, a polynomial obfuscation function is selected. The selected obfuscation function is monotonic and allows the data elements to be compared by comparing their corresponding obfuscated values. In some embodiments, one or more parameters for the obfuscation function are automatically determined based at least in part on a secret value. For example, a secret key is determined using a cryptographic random number generator. The secret key is used to determine one or more parameters, such as the coefficients, for the obfuscation function. Using one or more processors, the protected dataset is automatically obfuscated to generate an obfuscated version using the obfuscation function with the determined one or more parameters. For example, the elements of the protected dataset can be obfuscated by applying the obfuscation function with the determined one or more parameters to each element of the protected dataset. The generated obfuscated versions of the data elements can be stored in a separate column in a database table separate from the plain text values of the data elements.

In some embodiments, computer access to the obfuscated version of the protected dataset is provided as a comparable alternative for the protected dataset. For example, comparison queries between two elements of the obfuscated dataset and/or between an element of the obfuscated dataset and a constant value are provided. The comparison queries operate only on the obfuscated data and do not require access to the plain text values of the protected dataset. In some embodiments, the comparison queries can require providing the secret key, for example, to obfuscate a query parameter that is a constant value. In some embodiments, the comparison queries are provided by an obfuscation service that has access to only the obfuscated values and not the plain text values.

In various embodiments, an obfuscation service provides the ability to obfuscate a dataset while also allowing comparison queries to be performed on the obfuscated data elements. The obfuscation service utilizes an obfuscation function to obfuscate each of the data elements in the protected dataset. For example, a corresponding column in a database table can store the obfuscated versions of each data element and access to the data elements can be limited to the versions stored in the obfuscated column. In some embodiments, the obfuscation function is a one-way function that maps a confidential domain value x to a non-confidential range value ƒ(x) where A [symbol] ƒ(A) and B [symbol] ƒ(B) such that A<B is equivalent to ƒ(A)<ƒ(B). The comparison of the confidential values A and B can be reduced to the comparison of the non-confidential values ƒ(A) and ƒ(B). For example, the comparison of confidential values A and B can be applied to monetary values such as prices, offer amounts, salaries, etc.

In some embodiments, the disclosed technique and obfuscation function can be stated in terms of a general n-ary predicate P(x₁, x₂, . . . , xₙ) that is evaluated over n domains S₁, S₂, . . . , Sₙ. The predicate P can be written as a truth-valued function

P: S₁×S₂× . . . ×Sₙ→{true, false}.

The predicate P can be written using a mathematical set notation as a subset

P⊆S₁×S₂× . . . ×Sₙ.

In some embodiments, for a given predicate P, a function ƒ is constructed where

ƒ: S₁∪S₂∪ . . . ∪Sₙ→

[symbol]

and a predicate P′ such that

P(x₁, x₂, . . . , xₙ)⇔P′(ƒ(x₁), ƒ(x₂), . . . , ƒ(xₙ))

This equivalence states that the evaluation of P on confidential values xᵢ can be replaced with the evaluation of P′ on non-confidential values ƒ(xᵢ). In some embodiments, all Sᵢ are equal and P is a common binary predicate, e.g., P⊂ [symbol] × [symbol] with P=“<” is the linear order on [symbol] and then ƒ becomes ƒ: [symbol] → [symbol] .

In various embodiments, the obfuscation techniques are applied to specific real-world domains and the domains Sᵢ are not generic abstract sets such as the infinite set of integers [symbol] , but specific semantic real-world domains such as the set of U.S. ZIP codes, U.S. social security numbers, or credit card numbers. In some embodiments, a prerequisite requires that the values (e.g., A and B) must be kept confidential. Knowing the value W, where ƒ(A)=W, and knowing the function ƒ(x) itself is insufficient (without potentially extreme computational power) to determine the value of A. A function ƒ(x) with this property is denoted as a one-way function (OWF).

In some embodiments, the disclosed techniques and obfuscation functions can be stated in a modified form. For a list of (possibly small) domains

S₁, S₂, . . . , Sₙ

and a predicate

P⊆S₁×S₂× . . . ×Sₙ

the disclosed techniques construct a one-way function

ƒ: S₁∪S₂∪ . . . ∪Sₙ×K→

[symbol]

and a predicate P′ such that

P(x₁, x₂, . . . , xₙ)⇔P′(ƒ(x₁, s), ƒ(x₂, s), . . . , ƒ(xₙ, s)).

Using this construction, one or more domain values xᵢ∈Sᵢ can be kept confidential and the predicate P can be evaluated on the non-confidential function values ƒ(xᵢ, s) with the predicate P′.

In selecting an obfuscation function, a polynomial

ƒ(x)=aₙxⁿ+aₙ₋₁xⁿ⁻¹+ . . . +a₁x+a₀

of degree n with integer coefficients can be used. Depending on the presence of turning points, the polynomial ƒ(x) is globally or piecewise monotonic. The monotonically increasing function is an order preserving function. For example, the function ƒ: D→R

if x₁<x₂⇔ƒ(x1)<ƒ(x2)
then ƒ is monotonically increasing.

In various embodiments, given a particular semantic domain S, the distribution of S in the large range R of the polynomial is set by the coefficients of the polynomial. A secret parameter or key s can be utilized for the determination of the coefficients a₀, a₁, . . . , aₙ for a specific semantic domain S and a specific polynomial ƒ(x) to create the obfuscation function. In various embodiments, the polynomial

F(x, s)=aₙxⁿ+aₙ₋₁xⁿ⁻¹+ . . . +a₁x+a₀

is constructed with the following properties.
The key s∈K is chosen at random from a sufficiently large domain K. For example, in some embodiments, |K|≥2¹²⁸.
The key s is kept secret to ensure the one-way property of F(x, s).
The degree n of F(x, s) is selected in accordance with the size of the semantic domain S, the artificial key-space K, and the desired range R of F(x, s). In some embodiments, the degree n of F(x, s) is further selected in accordance with the value and/or size of the key s.
There are n+1 coefficient generating functions

Cₙ(s, n), Cₙ₋₁(s, n), . . . , C₁(s, n), C₀(s, n)

such that each Cᵢ(s, n) uses the key s and the degree n to generate the corresponding coefficient aᵢ:

Cᵢ(s, n)=aᵢ

Cn(s, n)=aₙ≠0.

These functions are constructed such that entire randomness/entropy of the key is passed to the coefficients of F(x, s), the values of F(x, s) are within the range R, and F(x, s) is monotonic on the semantic domain S for all keys in K.

In various embodiments, the constructed polynomial F(x, s) is a domain-specific one-way function and/or a domain-specific message authentication code for the semantic domain S, with the key-space K, and the bounded range R. The polynomial F(x, s) has the additional property of being order-preserving for a given s∈K. For a given s, s can be a selector of a particular polynomial where ƒₛ(x)=F(x, s). For all x₁, x₂∈S:

x₁<x₂⇔ƒₛ(x₁)<ƒₛ(x₂)

or

x₁<x₂⇔ƒₛ(x₁)>ƒₛ(x₂).

In the event ƒₛ is monotonically decreasing, the decreasing function is turned into an order preserving one by replacing ƒₛ(x) with −ƒₛ(x).

In some embodiments, a sparse polynomial of degree 5 (or another appropriate degree) with positive coefficients is used for the obfuscation function. For example, ƒₛ(x)=ax⁵+bx²+c is monotonically increasing on [symbol] ⁺. The leading coefficient a spreads S across all of R. For example, the highest order term, ax⁵ in the example, determines the size of the polynomial's range. The quadratic term with b adds a non-linear distortion to the spreading and should be configured to have approximately the same magnitude as the leading term. In various embodiments, a polynomial of at least degree 5 prevents algebraic inversion, although in some instances, a lower degree may be appropriate. In various embodiments, the secret parameter or key s can be selected from a selector domain D. For example, with |D|=2²⁴⁸, a parameter s can be selected using a cryptographic random number generator where s∈D and the length of s is 248 bits long. The parameter s is a key that is kept secret and can be made inaccessible to non-trusted parties. With the secret key parameter s selected, the coefficients can be determined. In some embodiments, the coefficients are set according to the following rules:
a is fit into the high-order part of s, e.g., a=s[1, 152],
b is fit into the low-order part of s, e.g., b=s[41, 248], and
c=s
   to create the monotonic one-way obfuscation function

F(x, s)=ƒₛ(x)=ax⁵+bx²+c

for the semantic domain S. In various embodiments, this selection of the coefficients from parameter s is but one appropriate approach. Other selection techniques are appropriate as well. For example, a and b can be selected from the low-order and high-order parts of s, respectively. In some embodiments, the selection indices for a, b, c do not necessarily overlap. In some embodiments, a different length is selected for parameter s. For example, the length of secret parameter s can be selected based on the size of the domain D and/or the number of bits to utilize for the evaluated values of ƒₛ(x).

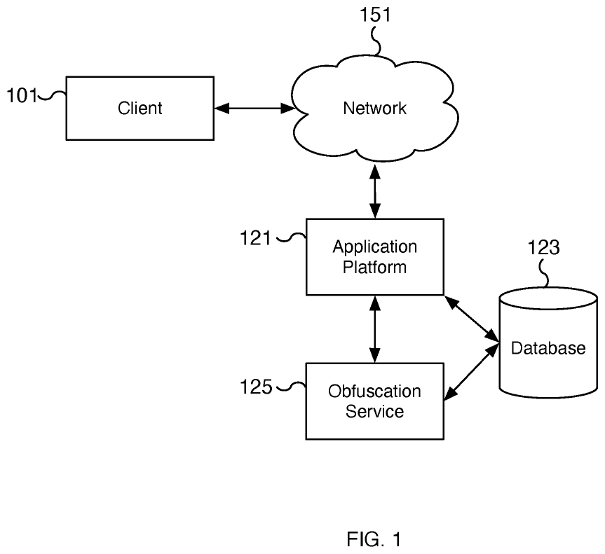

FIG. 1 is a block diagram illustrating an embodiment of an obfuscation system that preserves comparability. In the example shown, client 101 accesses cloud-based application platform 121 via network 151. Network 151 can be a public or private network. In some embodiments, network 151 is a public network such as the Internet. Application platform 121 hosts cloud application services that utilize protected datasets. These protected datasets can include confidential and sensitive values such as salaries, birthdates, medical and/or health metrics, safety rankings, and/or employee performance ratings, among other confidential numeric values. Application platform 121 utilizes obfuscation service 125 to obfuscate the protected datasets while preserving the ability to compare the obfuscated values within each dataset. Obfuscation service 125 utilizes a monotonic one-way obfuscation function to map the confidential domain of a protected dataset to a non-confidential range value while preserving linear order. Both application platform 121 and obfuscation service 125 can utilize database 123 for storing and/or querying the protected and/or obfuscated data. For example, the protected data can be stored in and retrieved from database 123 in encrypted form by application platform 121 and in obfuscated form by obfuscation service 125 using different database tables and/or columns with the appropriate access permissions.

In some embodiments, client 101 is a network client for accessing application services of application platform 121. For example, using a web browser client, client 101 can access web services hosted by an application service of application platform 121. In some embodiments, client 101 is a desktop computer, a laptop, a mobile device, a tablet, a kiosk, a voice assistant, a wearable device, or another network computing device. In various embodiments, client 101 can perform comparison queries on confidential data via application platform 121 such as determining whether a value A is larger than a value B without application platform 121 (and obfuscation service 125) having access to the values A and B. The support for querying confidential data via application platform 121 is provided by obfuscation service 125. In various embodiments, client 101 requires a secret key to create and/or query each obfuscated dataset.

In some embodiments, application platform 121 offers cloud-based application services including the ability to store and compare protected data. For example, confidential data is stored in an obfuscated format using obfuscation service 125. Application platform 121 offers a front-end for performing comparison queries on the dataset once obfuscated. The comparison queries can include comparing which of two obfuscated data elements is larger (or smaller) as well as comparing one obfuscated data element to a provided constant value. In various embodiments, the obfuscation functionality is provided by obfuscation service 125.

In some embodiments, obfuscation service 125 is an obfuscation service that maps a confidential domain value x to a non-confidential range value ƒ(x) while preserving linear order. Obfuscation service 125 utilizes a monotonic one-way polynomial obfuscation function. In various embodiments, the coefficients of the obfuscation function are generated for each protected dataset from a secret key. Using the obfuscation function, obfuscation service 125 can obfuscate a dataset, converting each data element into a corresponding obfuscated value. Since the obfuscation function is monotonic, the resulting obfuscated values can be compared with one another instead of comparing the plain text versions of the data elements. This allows obfuscation service 125 to perform comparison queries on the protected dataset using the obfuscated values without requiring a stored copy of the confidential data elements in plain text form. Although described as an obfuscation service that includes the ability to compare obfuscated versions of data elements, the functionality offered can be accessed via other techniques as well, such as via an application programming interface (API) or another appropriate interface.

In some embodiments, database 123 is utilized by application platform 121 and/or obfuscation service 125 as a data store for storing and/or retrieving data including data elements of a protected dataset. For example, data elements can be converted to their obfuscated form by obfuscation service 125 and stored in database 123. In some embodiments, the data elements are additionally stored in plain text and/or encrypted formats in database 123. For example, a user account associated with client 101 may be configured to access plain text versions and/or to decrypt encrypted versions of the protected data elements from database 123 whereas obfuscation service 125 may be configured to only access obfuscated versions of the protected data elements from database 123.

Although single instances of some components have been shown to simplify the diagram of FIG. 1, additional instances of any of the components shown in FIG. 1 may exist. For example, application platform 121 and/or obfuscation service 125 may include one or more servers and/or may share servers. Furthermore, client 101 is just one example of a potential client to application platform 121. Similarly, database 123 may include one or more database servers. In some embodiments, database 123 may not be directly connected to application platform 121 and/or obfuscation service 125. For example, database 123 and its components may be replicated and/or distributed across multiple servers and/or components. In some embodiments, components not shown in FIG. 1 may also exist.

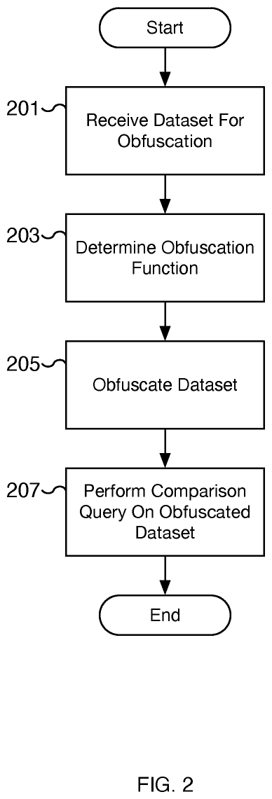

FIG. 2 is a flow chart illustrating an embodiment of a process for obfuscating a dataset while preserving comparability. In various embodiments, the process of FIG. 2 is performed by an obfuscation service for a dataset that requires protection. For example, a client accessing an application service can request a confidential dataset be obfuscated and that the obfuscated dataset preserve comparability. Utilizing an obfuscation service accessible from the application service, each of the data elements can be converted into a corresponding obfuscated value. Once the dataset is obfuscated, comparison queries against the dataset can be performed using the obfuscated values. For example, a comparison query can be performed by the obfuscation service to determine which of two obfuscated values and their corresponding non-obfuscated plain text values is larger (or smaller). In some embodiments, the client is client 101 of FIG. 1, the application service is hosted by application platform 121 of FIG. 1, and the obfuscation service is obfuscation service 125 of FIG. 1.

At 201, a dataset is received for obfuscation. For example, a dataset of elements such as numerical values is received for obfuscation. In some embodiments, the dataset corresponds to currency values (e.g., salaries, sales, bids, etc.), birthdates and/or ages, medical and/or health metrics (e.g., height, weight, health risk, etc.), safety rankings, employee performance ratings, and/or confidential business information values (e.g., transaction values), among other confidential numeric values. The dataset may be provided due to the confidential nature of the values in the dataset and access to the actual values needs to be limited. In some embodiments, the dataset can be stored in encrypted format with limited access to the ability to decrypt the encrypted values.

At 203, an obfuscation function is determined. For example, using the dataset received, a monotonic one-way obfuscation function is determined. In some embodiments, a unique obfuscation function is used for each dataset and the determined function differs depending on the requirements of the dataset. For example, a different obfuscation function can be used depending on the range of potential values of the dataset. In some embodiments, the obfuscation function selected depends on the size of the dataset domain, the size of a provided secret K or the key-space, and/or the desired range of the obfuscated values. In various embodiments, the obfuscation function is a polynomial of degree n, where n can be selected based on the obfuscation requirements. In some embodiments, the coefficients of the polynomial function are positive and are set based on a secret key. The determined obfuscation function for the dataset is a one-way function that maps a confidential dataset value to a non-confidential value while preserving linear order.

At 205, the dataset is obfuscated. Using the obfuscation function determined at 203, the data elements of the dataset are converted to their corresponding obfuscated values. Since the obfuscation function is monotonic, the obfuscated values preserve the linear order of the dataset. In some embodiments, the obfuscated values are stored in a new database table and/or column associated with the dataset. For example, a patient table can include columns for a patient identifier as a primary key and a confidential age value. For comparison purposes, the age value can be replaced with an obfuscated age. The obfuscated age can be stored in a new column and access to the confidential age column can be limited. In some embodiments, a new table is created replacing the confidential age value with the obfuscated age value for each patient and access to the original table with the confidential age is limited.

At 207, a comparison query is performed on the obfuscated dataset. For example, using the dataset obfuscated at 205, a comparison query can be performed. In some embodiments, the comparison query references two obfuscated data elements that are compared to one another. Additional types of comparison queries are appropriate as well. For example, a comparison query can compare an obfuscated data element to a known value, such as a constant value, by first obfuscating the known value and then comparing the two obfuscated values. In some embodiments, the type of comparison query can return multiple entries such as all rows with obfuscated values that evaluate true for a comparison operator. For example, extending the example from step 205, the confidential values for ages can be required for comparison, such as a query for all patients under the age of 18. Instead of accessing the confidential ages of each patient, the obfuscated ages can be compared to the obfuscated value of age 18 to return all patient identifiers with an age less than 18.

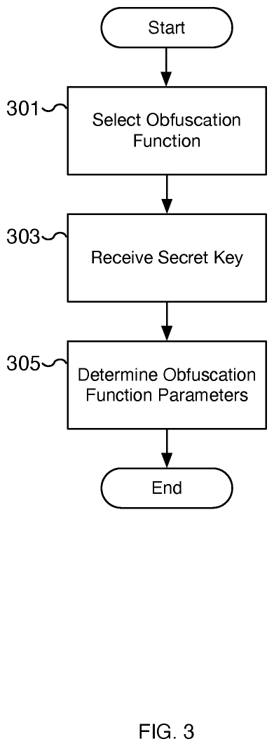

FIG. 3 is a flow chart illustrating an embodiment of a process for determining an obfuscation function that preserves comparability. In various embodiments, the process of FIG. 3 is performed by an obfuscation service for a dataset that requires protection. For example, using the process of FIG. 3, an obfuscation function for a dataset that requires protection is created. In various embodiments, the created obfuscation function is a monotonic one-way polynomial function with coefficients generated for each protected dataset from a secret key. In some embodiments, the process of FIG. 3 is performed at 203 of FIG. 2. In some embodiments, the obfuscation service is obfuscation service 125 of FIG. 1.

At 301, an obfuscation function is selected. For example, in selecting an obfuscation function, a polynomial of degree n with integer coefficients can be used. The selected polynomial is a domain-specific one-way function and/or a domain-specific message authentication code for the semantic domain S of the protected dataset, with the key-space K, and the bounded range R. The polynomial has the additional property of being order-preserving for a given s∈K, where the secret key s is utilized for the selecting of the coefficients of the polynomial. For a given s, s can be a selector of a particular polynomial where ƒₛ(x)=F(x, s). For all x₁, x₂∈S:

x₁<x₂⇔ƒₛ(x₁)<ƒₛ(x₂)

or

x₁<x₂⇔ƒₛ(x₁)>ƒₛ(x₂).

In the event ƒₛ is monotonically decreasing, the decreasing function is turned into an order preserving one by replacing ƒₛ(x) with −ƒₛ(x).

In some embodiments, a sparse polynomial of degree 5 (or another appropriate degree) with positive coefficients is used for the obfuscation function. In various embodiments, a polynomial of at least degree 5 prevents algebraic inversion, although in some instances, a lower degree may be appropriate. The degree n can be selected in accordance with the size of the semantic domain S of the protected dataset, the artificial key-space K, and the desired range R of the obfuscation function. In some embodiments, the degree n is further selected in accordance with the value and/or size of the expected secret key s.

At 303, a secret key is received. For example, a secret key s is selected and received for use with the protected dataset. In some embodiments, the secret key is selected using a cryptographic random number generator. The key can be of varying bit length; however, a sufficiently large key is selected for encoding the coefficients of the obfuscation function polynomial. In some embodiments, the length of secret key s can be selected based on the size of the dataset domain and/or the number of bits to utilize for the obfuscated values. For example, a key of length 248 bits or another appropriate size can be selected and is received at 303.

At 305, obfuscation function parameters are determined. Using the secret key received at 303, obfuscation function parameters are determined. For example, the secret key is used to select the coefficients of the obfuscation function polynomial. By providing the secret key, the obfuscation function polynomial for the corresponding dataset can be prepared. In some embodiments, the coefficients are set according to the following rules:
a is fit into the high-order part of s, e.g., a=s[1, 152],
b is fit into the low-order part of s, e.g., b=s[41, 248], and
c=s
   to create the monotonic one-way obfuscation function

F(x, s)=ƒₛ(x)=ax⁵+bx²+c

for the semantic domain S of the protected dataset. In various embodiments, this selection of the coefficients from secret key s is but one appropriate approach for encoding the coefficients using the secret key. Other selection techniques are appropriate as well. For example, a and b can be selected from the low-order and high-order parts of s, respectively. In some embodiments, the selection indices for a, b, c do not necessarily overlap. In some embodiments, a different length is selected for secret key parameter s. For example, the length of secret key parameter s can be selected based on the size of the dataset domain D and/or the number of bits to utilize for the evaluated values of ƒₛ(x).

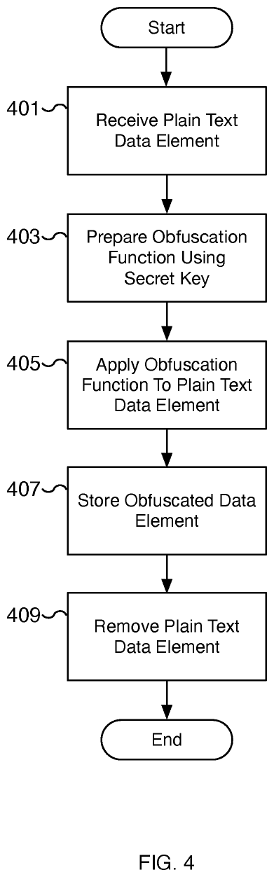

FIG. 4 is a flow chart illustrating an embodiment of a process for protecting a dataset using an obfuscation function. In various embodiments, the process of FIG. 4 is performed by an obfuscation service for data elements of a dataset that require protection. For example, using the process of FIG. 4, an obfuscation service applies an obfuscation function determined for the dataset to convert a data element of the dataset into its corresponding obfuscated value. In various embodiments, the obfuscation function is applied using a secret key associated with the dataset. In some embodiments, the process of FIG. 4 is performed at 205 of FIG. 2 using an obfuscation function determined at 203 of FIG. 2 and/or using the process of FIG. 3. In some embodiments, the obfuscation service is obfuscation service 125 of FIG. 1.

At 401, the plain text form of a data element is received. For example, a plain text value for a data element is received for obfuscation. The plain text value can be a currency value (e.g., a salary amount, a sale price, a bid price, etc.), a birthdate or age, a medical or health metric, a safety ranking, an employee performance rating, and/or a confidential business information value, among other confidential numeric values.

At 403, the obfuscation function is prepared using an associated secret key. For example, the coefficients of a monotonically increasing polynomial obfuscation function are set using a secret key. In some embodiments, the secret key s is selected using a cryptographic random number generator where the length of s is 248 bits long (or another appropriate length). In some embodiments, the obfuscation function is a sparse polynomial of degree n, such as n=5, with positive coefficients. For example, the polynomial ƒₛ(x)=ax⁵+bx²+c can be used for the obfuscation function and the coefficients a, b, and c are set using the secret key s. As one example, the coefficients are set according to the following rules:
a is fit into the high-order part of s, e.g., a=s[1, 152],
b is fit into the low-order part of s, e.g., b=s[41, 248], and
c=s
   to create the monotonic one-way obfuscation function

F(x, s)=ƒₛ(x)=ax⁵+bx²+c

for the semantic domain S of the protected dataset. In various embodiments, this selection of the coefficients from secret key s is but one appropriate approach. Other selection techniques are appropriate as well. For example, a and b can be selected from the low-order and high-order parts of s, respectively. In some embodiments, the selection indices for a, b, c do not necessarily overlap. In some embodiments, a different length is selected for secret key parameter s. For example, the length of secret key parameter s can be selected based on the size of the dataset domain D and/or the number of bits to utilize for the evaluated values of ƒₛ(x).

At 405, the obfuscation function is applied to the plain text form of a data element. Using the obfuscation function prepared at 403, the plain text value of the data element received at 401 is converted to an obfuscated value. Since the obfuscation function is a one-way function, given the obfuscated value alone, the plain text form of the data element cannot be determined.

At 407, the obfuscated data element is stored. For example, once the obfuscated value of the data element is determined, the obfuscated value is stored for performing comparison queries. In some embodiments, the obfuscated value is stored in a database such as in a corresponding database column for the obfuscated values. The database column for the obfuscated value can be associated with other columns that allow the obfuscated value to be joined with related information, such as a patient identifier, a customer name, an employee number, etc.

At 409, the plain text form of the data element is removed. Once the obfuscated data element is stored, access to the plain text value of the data element is no longer needed for comparison purposes. For improved security, the plain text form of the data element is removed. In some embodiments, the memory used for storing the plain text value is wiped so that the value cannot be restored. In some embodiments, permissions for database tables and/or columns with the plain text form of the data element are configured to remove access from untrusted sources. For example, the plain text form of the data element can be removed by removing access to the corresponding database table and/or column.

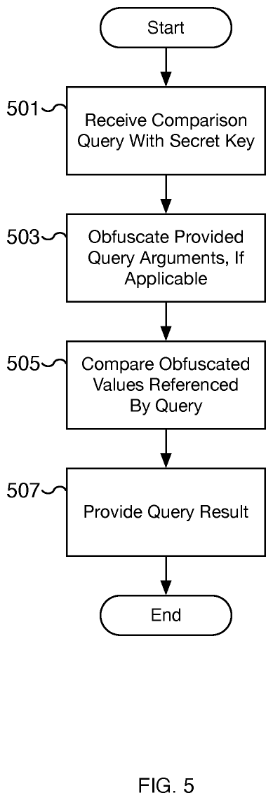

FIG. 5 is a flow chart illustrating an embodiment of a process for performing a comparison query on an obfuscated dataset. In various embodiments, the process of FIG. 5 is performed by an obfuscation service on an obfuscated dataset to determine comparison results applicable to the corresponding non-obfuscated data elements. For example, a comparison query can be performed by the obfuscation service to determine which of two obfuscated values is larger (or smaller) and the result is applied to the corresponding non-obfuscated plain text values. In some embodiments, the process of FIG. 5 is performed at 207 of FIG. 2 using an obfuscation function determined at 203 of FIG. 2 and/or using the process of FIG. 3. In some embodiments, the protected dataset is obfuscated at 205 of FIG. 2 and/or using the process of FIG. 4. In some embodiments, the client is client 101 of FIG. 1, the application service is hosted by application platform 121 of FIG. 1, and the obfuscation service is obfuscation service 125 of FIG. 1.

At 501, a comparison query is received with a secret key. For example, a comparison query is received that specifies two query arguments to be compared. The comparison operation can be a greater than, less than, or equal operation. In some embodiments, the two arguments reference two obfuscated data elements of the protected dataset. In some embodiments, the two arguments include a first argument that references an obfuscated data element of the protected dataset and a second argument that is a non-obfuscated value such as a constant value in plain text form. Along with the comparison query, a secret key associated with the obfuscated dataset is received. The secret key is used to determine one or more parameters for the obfuscation function used for the dataset associated with the query. In various embodiments, additional types of comparison queries can be supported as well, such as a query that compares an obfuscated data element to a range of non-obfuscated values.

At 503, applicable provided query arguments are obfuscated. For example, one or more non-obfuscated values of the provided query are obfuscated using the obfuscation function associated with the dataset. In some embodiments, the obfuscation function is determined using the provided secret key. For example, using the process of FIG. 3, the same obfuscation function used to obfuscate the protected dataset is determined using the provided secret key. Once determined, the obfuscation function is applied to non-obfuscated values to evaluate corresponding obfuscated values used in performing a comparison operation at 505.

At 505, obfuscated values referenced by the query are compared. Using only the corresponding obfuscated values, a comparison operation is performed for the query arguments. For example, for a query referencing two obfuscated data elements for comparison, the values of the obfuscated data elements referenced by the query are retrieved from the appropriate database and compared with one another. As another example, for queries where an obfuscated data element is queried for comparison to a non-obfuscated value, the value of the obfuscated data element referenced by the query is retrieved from the appropriate database and compared to the obfuscated value determined at 503. Other comparison query operations with appropriate obfuscated and non-obfuscated data elements, values, and ranges as arguments can be performed as well. In some embodiments, the comparison is performed by a database query engine using the obfuscated values stored in the appropriate database. In various embodiments, the results of the comparison operation include a determination of which of two arguments is larger than the other and/or whether the two arguments have the same value.

At 507, the query result is provided. For example, the result of the comparison query performed at 505 is provided. Although the query is performed on the obfuscated values, the results are applicable to the corresponding non-obfuscated values of the protected dataset due to the order preserving property of the obfuscation function used by the obfuscation service. In some embodiments, the query result is used by the application service for performing different business logic as part of an application service for the client.

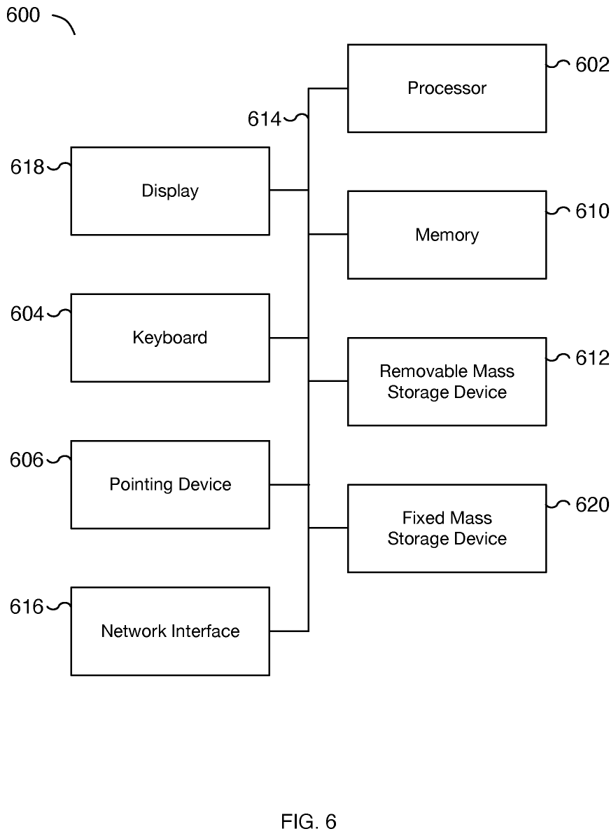

FIG. 6 is a functional diagram illustrating a programmed computer system for obfuscating a dataset while preserving comparability in accordance with some embodiments. As will be apparent, other computer system architectures and configurations can be utilized for order-preserving obfuscation of a protected dataset and/or performing comparison queries on the obfuscated data. Examples of computer system 600 include client 101 of FIG. 1, one or more computers of application platform 121 of FIG. 1, and one or more computers of obfuscation service 125 of FIG. 1. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618). In various embodiments, one or more instances of computer system 600 can be used to implement at least portions of the processes of FIGS. 2-5.

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data and objects used by the processor 602 to perform its functions (e.g., programmed instructions). For example, memory 610 can include any suitable computer-readable storage media, described below, depending on whether, for example, data access needs to be bi-directional or unidirectional. For example, processor 602 can also directly and very rapidly retrieve and store frequently needed data in a cache memory (not shown).

A removable mass storage device 612 provides additional data storage capacity for the computer system 600, and is coupled either bi-directionally (read/write) or unidirectionally (read only) to processor 602. For example, storage 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storages 612, 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining to obfuscate a protected dataset including data elements that are to remain comparable with one another after the obfuscation;
selecting an obfuscation function for the protected dataset, wherein the obfuscation function is a monotonic one-way function;
automatically determining one or more parameters for the obfuscation function based at least in part on a secret value;
using one or more processors to automatically obfuscate the protected dataset to generate an obfuscated version using the obfuscation function with the determined one or more parameters; and
providing computer access to the obfuscated version of the protected dataset as a comparable alternative for the protected dataset.

2. The method of claim 1, wherein the data elements include one or more of the following: currency values, birthdates, ages, medical metrics, health metrics, rankings, ratings, or confidential business information values.

3. The method of claim 1, further comprising creating a new column in a database table for storing the obfuscated version of the protected dataset.

4. The method of claim 1, wherein providing the computer access to the obfuscated version of the protected dataset as the comparable alternative for the protected dataset includes performing a comparison query, wherein the comparison query references a first argument, and wherein the first argument includes an obfuscated value included in the obfuscated version of the protected dataset.

5. The method of claim 4, wherein the comparison query references a second argument, and wherein the second argument includes an obfuscated value included in the obfuscated version of the protected dataset.

6. The method of claim 4, wherein the comparison query references a second argument, and wherein the second argument is a non-obfuscated value.

7. The method of claim 6, further comprising:
automatically obfuscating the second argument; and
comparing the first argument with the obfuscated second argument.

8. The method of claim 1, further comprising removing access to the protected dataset, wherein the protected dataset is stored as plain text values.

9. The method of claim 1, wherein the obfuscation function includes a polynomial with one or more positive coefficients.

10. The method of claim 9, wherein automatically determining the one or more parameters for the obfuscation function based at least in part on the secret value includes setting each of the one or more positive coefficients of the obfuscation function using at least a portion of the secret to value.

11. The method of claim 9, wherein the polynomial is of a degree of at least 5.

12. The method of claim 9, wherein a degree of the polynomial is selected based on one or more of the following: a size of a domain of the protected dataset, a key-space of the secret value, a desired range of obfuscate values of the protected dataset, or a size of the secret value.

13. The method of claim 1, wherein the secret value is selected using a cryptographic random number generator.

14. A system, comprising:
one or more processors; and
a memory coupled to the one or more processors, wherein the memory is configured to provide the one or more processors with instructions which when executed cause the one or more processors to:
determine to obfuscate a protected dataset including data elements that are to remain comparable with one another after the obfuscation;
select an obfuscation function for the protected dataset, wherein the obfuscation function is a monotonic one-way function;
automatically determine one or more parameters for the obfuscation function based at least in part on a secret value;
automatically obfuscate the protected dataset to generate an obfuscated version using the obfuscation function with the determined one or more parameters; and
provide computer access to the obfuscated version of the protected dataset as a comparable alternative for the protected dataset.

15. The system of claim 14, wherein the memory is further configured to provide the one or more processors with the instructions which when executed cause the one or more processors to create a new column in a database table for storing the obfuscated version of the protected dataset.

16. The system of claim 14, wherein causing the one or more processors to provide the computer access to the obfuscated version of the protected dataset as the comparable alternative for the protected dataset includes causing the one or more processors to perform a comparison query, wherein the comparison query references a first argument, and wherein the first argument includes an obfuscated value included in the obfuscated version of the protected dataset.

17. The system of claim 16, wherein the comparison query references a second argument, and wherein the second argument is a non-obfuscated value.

18. The system of claim 14, wherein the obfuscation function includes a polynomial with one or more positive coefficients.

19. The system of claim 18, wherein causing the one or more processors to automatically determine the one or more parameters for the obfuscation function based at least in part on the secret value includes causing the one or more processors to set each of the one or more positive coefficients of the obfuscation function using at least a portion of the secret value.

20. A computer program product, the computer program product being embodied in a non-transitory computer readable storage medium and comprising computer instructions for:
determining to obfuscate a protected dataset including data elements that are to remain comparable with one another after the obfuscation;
selecting an obfuscation function for the protected dataset, wherein the obfuscation function is a monotonic one-way function;
automatically determining one or more parameters for the obfuscation function based at least in part on a secret value;
automatically obfuscating the protected dataset to generate an obfuscated version using the obfuscation function with the determined one or more parameters; and
providing computer access to the obfuscated version of the protected dataset as a comparable alternative for the protected dataset.
